(19) United States
(12) Patent Application Publication
(10) Pub. No.: US 2026/0108779 A1
(43) Pub. Date: Apr. 23, 2026

(54) BALL SPIN AXIS DETERMINATION

(71) Applicant: TOPGOLF SWEDEN AB, Danderyd (SE)

(72) Inventors: Kent Bertilsson, Skogas (SE); Anton Jansson, Stockholm (SE)

(21) Appl. No.: 19/117,622

(22) PCT Filed: Sep. 29, 2023
(86) PCT No.: PCT/EP2023/076996

§ 371 Date: Apr. 1, 2025

(30) Foreign Application Priority Data
Oct. 4, 2022 (SE) 2230320-0

(51) Int. Cl. A63B 24/00; G06F 17/11

(52) U.S. Cl. CPC A63B 24/0021; G06F 17/11; A63B 2024/0034

(57) ABSTRACT

Methods and apparatus, including computer program products, implementing, and using techniques for determining a spin axis of a ball in flight. At least a portion of an observed trajectory of the ball is obtained. The trajectory includes three-dimensional locations of the ball over time, as determined from individual observations of the ball by one or more sensors. A point in three-dimensional space is selected. An optimization problem is solved, wherein the three-dimensional acceleration at the selected point is used as an optimization target, and a spin axis, a spin magnitude and a wind vector are used as optimization parameters, and wherein the solution to the optimization problem is a combination of optimization parameter values. The spin axis determined in the solution to the optimization problem is selected as the spin axis for the ball. The spin axis is used to generate ball trajectory information for presentation on an output device.

### BACKGROUND

The present invention relates to determination of a spin axis for an object, and more specifically, to determining a spin axis of a sports ball traveling through the air.

The spin axis of a sports ball (e.g., a golf ball, hereinafter simply referred to as a “ball”), refers to the axis around which the ball rotates during flight. The rotation around the spin axis gives rise to a lift force acting on the ball. The orientation of the spin axis affects the direction of the lift force on the ball, and therefore also the amount of curvature of a golf shot. The spin axis remains constant throughout the flight of the ball, even though the wind may “push” the ball in different directions, and is typically relative to the horizon. The spin axis can be considered analogous to the wings of an airplane, i.e., if the spin axis is parallel to the horizon, the ball will fly straight; if the spin axis is tilted to the left (i.e., the right wing higher than the left wing), the ball will curve to the left; and if the spin axis is tilted to the right (i.e., the left wing higher than the right wing), the ball will curve to the right.

It is often desirable to know the spin axis, for example, for purposes of developing clubs and other equipment, or for informational purposes for the player so she can make a reasonably accurate guess about how the ball will move through the air when the ball is impacted by a particular type of equipment in a particular way.

It is well-known that for a rotationally symmetric ball in flight, three main forces act on the ball: gravity, air resistance (also referred to as “drag”), and the “lift” of the ball, as described above. These forces can be represented by vectors, and together form the total acceleration of the ball. The total acceleration can be determined from positional measurements of the ball by cameras and/or radar sensors as the ball travels through the air along its trajectory. Typically, the trajectory observations are done in three orthogonal planes, that is, a horizontal plane (x-direction), a vertical plane (y-direction), and a depth plane (z-direction).

Using a set of simplifying assumptions and mathematical calculations, an estimate can be derived for the “lift,” which can be used to estimate a spin vector for the ball. From the estimated spin vector, a spin axis for the ball can be derived. However, the measured trajectory values are typically very noisy due to several factors, for example, inaccurate wind speed observations, the mathematical model used to represent the camera when converting camera images to distances, the accuracy by which directions/vectors can be determined, and the hardware of the cameras (e.g., the type of image sensors, etc.), just to mention a few possible sources of errors.

### SUMMARY

In some aspects, the techniques described herein relate to a method for determining a spin axis of a ball in flight, including: obtaining at least a portion of an observed trajectory of the ball, the observed trajectory comprising three-dimensional locations of the ball over time, as determined from individual observations of the ball by one or more sensors; selecting a point in three-dimensional space; solving an optimization problem, wherein a three-dimensional acceleration at the selected point in three-dimensional space is used as an optimization target, and a spin axis, a spin magnitude and a wind vector are used as optimization parameters, wherein a solution to the optimization problem is a combination of optimization parameter values; selecting, as a spin axis of the ball, the spin axis determined in the solution to the optimization problem; and using the selected spin axis of the ball to generate ball trajectory information to be presented on an output device.

In some embodiments, solving an optimization problem comprises: initializing values for the optimization parameters; calculating a regularized weighted loss function; optimizing m steps using a descent-based optimization; updating point weights; and repeating the calculating, optimizing, and weighting n times or until convergence.

In some embodiments, the sensor observation data is collected by one or more of: a radar, a camera, or both.

In some embodiments, the at least a portion of an observed trajectory of the ball is smoothed using a Savitzky-Golay filter.

In some embodiments, acceleration outliers are removed prior to solving the optimization problem.

In some embodiments, a wind velocity is obtained which represents prevailing wind conditions during the flight of the ball; and the obtained wind velocity is used when initializing the wind vector.

In some embodiments, the wind velocity is the wind velocity is obtained by estimating a systematic error between corresponding sections of an estimated trajectory of the ball and the observed trajectory of the ball.

In some embodiments, the three-dimensional acceleration of the ball in each selected point in three-dimensional space includes an acceleration component due to gravity, an acceleration component due to drag, and an acceleration component due to lift, and wherein the acceleration component due to lift is used to determine an initialization value for the spin axis.

In some embodiments, the ball is a golf ball, and the method is performed at a golf practice range or golf course.

In some embodiments, the regularized weighted loss function is a Huber loss function.

In some embodiments, it is determined whether the optimizing is converging, and in response to determining that the optimizing is converging, the repeating operation is performed fewer than n times.

In some embodiments, calculating a regularized weighted loss function is done by automatic differentiation.

In some embodiments, the descent-based optimization is a Broyden-Fletcher-Goldfarb-Shanno algorithm.

In some aspects, the techniques described herein relate to a computer software product arranged to, when executed, perform the method steps.

In some aspects, the techniques described herein relate to a system for determining a spin axis of a ball in flight, including: means for obtaining at least a portion of an observed trajectory of the ball, the observed trajectory comprising three-dimensional locations of the ball over time, as determined from individual observations of the ball by one or more sensors; means for selecting a point in three-dimensional space; means for solving an optimization problem, wherein the three-dimensional acceleration at the selected point in three-dimensional space is used as an optimization target, and a spin axis, a spin magnitude and a wind vector are used as optimization parameters, wherein the solution to the optimization problem is a combination of optimization parameter values; means for selecting, as a spin axis of the ball, the spin axis determined in the solution to the optimization problem; and means for using the selected spin axis of the ball to generate ball trajectory information to be presented on an output device.

In some aspects, the techniques described herein relate to a system for determining a spin axis of a ball in flight, including: means for obtaining at least a portion of an observed trajectory of the ball, the observed trajectory comprising three-dimensional locations of the ball over time, as determined from individual observations of the ball by one or more sensors; means for solving an optimization problem, by using a three-dimensional acceleration at a selected point in three-dimensional space as an optimization target, a combination of optimization parameter values for a spin axis, a spin magnitude and a wind vector; and means for presenting ball trajectory information to be presented on an output device, wherein the ball trajectory information includes the spin axis, as determined in the solution to the optimization problem.

The details of one or more embodiments of the invention are set forth in the accompanying drawings and the description below. Other features and advantages of the invention will be apparent from the description and drawings, and from the claims.

### BRIEF DESCRIPTION OF THE DRAWINGS

FIG. 1 is a schematic diagram of a spin axis determination system, in accordance with some embodiments.

FIG. 2 is a schematic diagram of a data processing system of the spin axis determination system, in accordance with some embodiments.

FIG. 3 is a flowchart illustrating the operation of the spin axis determination system when determining a spin axis for a ball in flight, in accordance with some embodiments.

FIG. 4 shows graphs of measured and smoothed acceleration values, respectively, for a ball in flight, in accordance with some embodiments.

FIG. 5 is a flowchart showing a wind velocity estimation method, in accordance with some embodiments

FIGS. 6A-6B schematically illustrate a user interface showing ball trajectories for a measured shot with a particular spin axis and an estimated shot under the same circumstances with a different spin axis, in accordance with some embodiments.

Like reference symbols in the various drawings indicate like elements.

### DETAILED DESCRIPTION

The various embodiments of the invention pertain to techniques for determining a spin axis for a ball in flight, based on recorded data about a trajectory traversed by a ball, such as a golf ball. In general, data captured by sensors, such as cameras and/or radars, as a ball flies through the air, is processed by software to generate a trajectory for the ball. From the generated trajectory, a spin axis is determined for the ball, by using a physics model that describes a relation between the acceleration of a ball and its spin axis and solving an optimization problem having the three-dimensional acceleration of the ball as an optimization target.

In some embodiments, noise in the observations from the sensors is managed in a first stage (i.e., prior to the optimization) by smoothing the raw sensor data, for example, using a Savitzky-Golay (SG) filter, and/or in a second stage during optimization by selecting an appropriate loss function, such as a Huber loss function. As a result, the spin axis determination using the systems and techniques described in herein make it possible to reduce the noise in the measured trajectory values and can therefore provide one or more advantages, including a more robust and accurate spin axis determination compared to what is currently possible, or conversely, permit the use of other types of sensors that otherwise would normally have provided data that is too noisy to be possible to use in the context of spin axis calculations. Since a difference as small as 1-2 degrees in the spin axis calculation can make a big difference when determining the trajectory of a ball, the optimization methods described herein can have a major impact on the accuracy of the spin axis calculation.

As was mentioned above, the determined spin axis can be used for a variety of purposes, such as developing clubs and other equipment, or for informational purposes for the player so she can make a reasonably accurate guess about how the ball will move through the air when the ball is impacted by a particular type of equipment in a particular way, or to simulate a part of a trajectory that cannot be measured, for example, in a game facility.

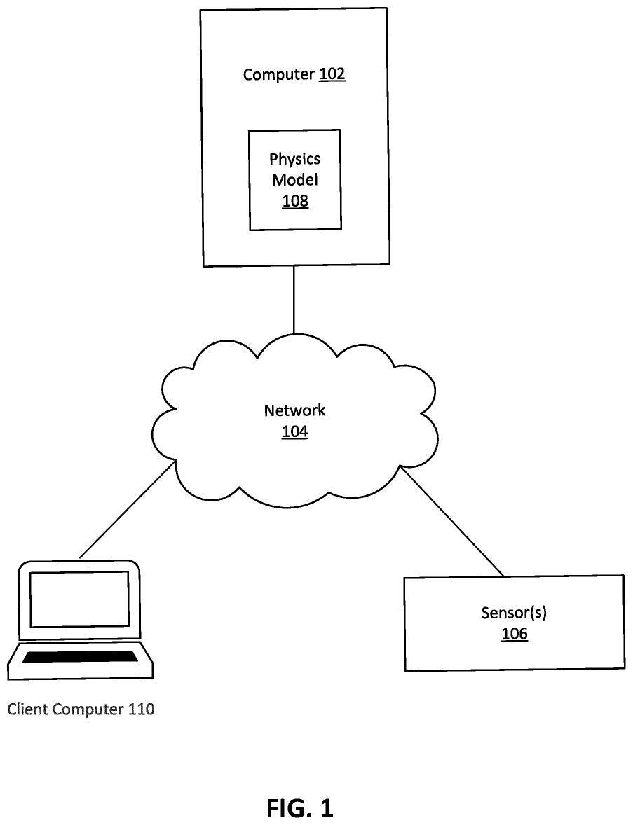

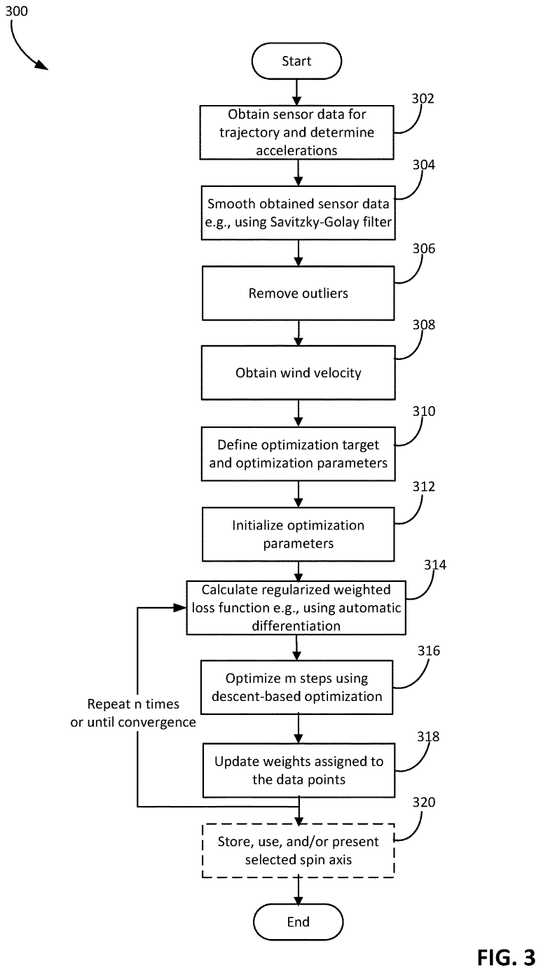

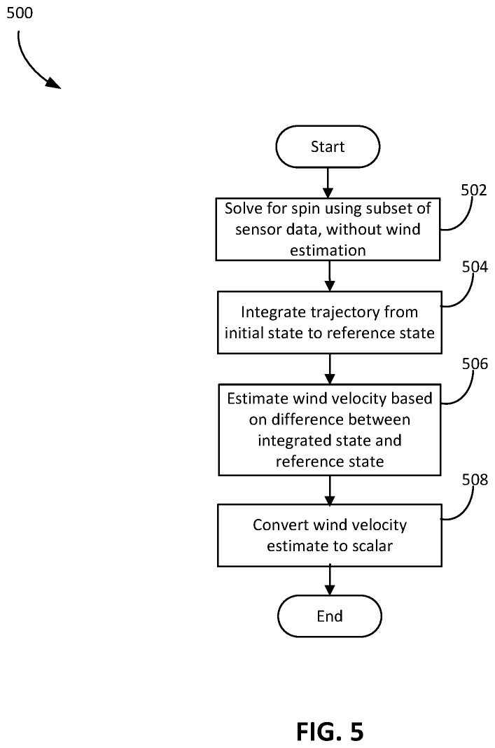

FIG. 1 shows a system, in which a computer 102 is configured to communicate over a network 104 with one or more sensors 106 to obtain data captured by the sensor(s) 106 for a ball in flight through a three-dimensional (3D) space. It should be noted that in some embodiments, the computer 102 does not communicate directly with the sensor(s) 106 but instead through an intermediary repository that stores data captured by the sensor(s) 106. It should also be noted that the sensor(s) 106 do not need to be permanently connected to the network 104 but can be detachably connected, e.g., through various types of interfaces such as USB-3 and similar. The computer 102 obtains data collected by the one or more sensor(s) 106 about individual trajectories for balls and applies a physics model 108 to the data to determine a spin axis, which can subsequently be used for various purposes. A more detailed description of the operations of the computer 102 in accordance with some implementations will be provided below with respect to the flowcharts of FIGS. 3 and 5.

The network 104 can be any combination of wired and/or wireless networks, including local networks, such as intranets, or global networks, such as the Internet. The network 104 can also include any combination of public and/or private networks.

The computer 102 can optionally communicate with a client computer 110, which can be used to display data relating to, for example, single shots, wind velocities, statistics, player data, etc., on a user interface. Various software applications can run on the client computer 110 to display the data in a preferred way to a user of the spin axis determination system. For example, the client computer 110 may contain software that presents the spin axis calculation for a recent shot to the user, along with a recommendation of one or more different types of clubs to try and what expected impact such a change of equipment would have on the ball trajectory. The computer 102 and/or the client computer 110 can be made using dedicated computer hardware or using shared computer hardware, which can be programed to produce a virtual processing environment corresponding to any suitable computer architecture.

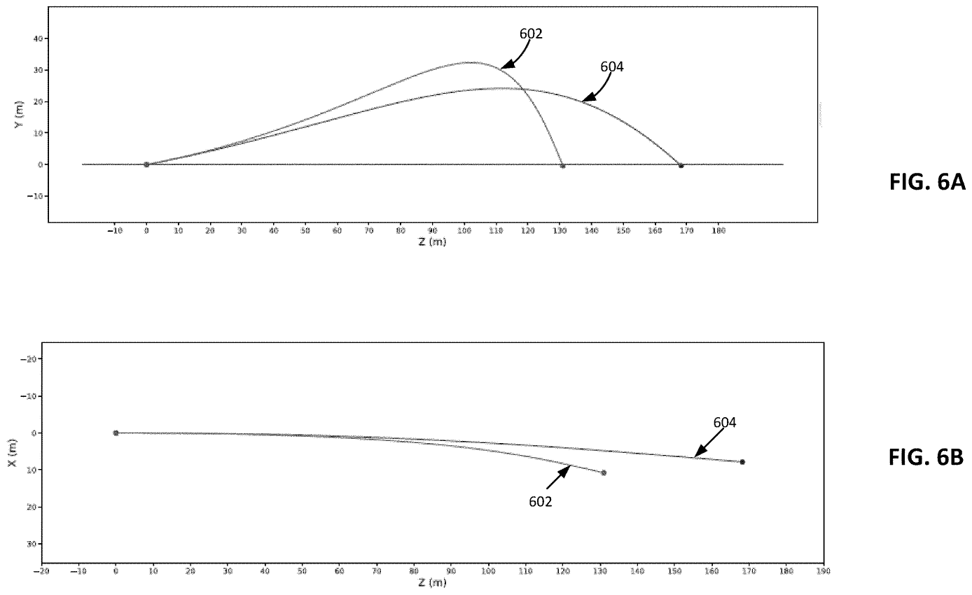

FIGS. 6A-6B show examples of graphs that can be displayed to a user on the user interface, in response to a selection being made by the user. In this case, the user has selected to show a comparison between two trajectories for the ball; one measured trajectory 602 for which the spin axis has been calculated, and one estimated trajectory 604 showing what the shot would have looked like if the spin axis had been slightly different, for example, as a result of using a different club, while other factors remain unchanged. By visualizing such comparisons on the user interface, the user can gain valuable information that will inform the user about how to adjust their technique or choice of clubs, for example, to become a better player.

As was mentioned above, the computer 102 obtains input data from a set of sensor(s) 106 that capture data about a ball in flight through a three-dimensional (3D) space. The ball can be, for example, a golf ball or another type of object that is struck, kicked, or thrown (e.g., a baseball, a soccer ball, or a football/rugby ball) to travel through the air. On a more general scale, the principles of the various embodiments of the invention described herein apply to any object where the Magnus effect (i.e., the path of the spinning object is deflected in a manner that is not present when the object is not spinning, due to the difference in pressure of the fluid on opposite sides of the spinning object and the speed of rotation) forms a significant part of the combined force acting on the object.

In some implementations, the 3D space is a golf practice area, such as a golf driving range; a grass field; or another open area into which objects can be launched. For example, the 3D space can be a playing area for a sport, such as a golf course, where the ball is struck from a launch area, such as a golf tee for a particular hole on the golf course, or an intermediate landing point for a golf ball in play on the course, to a target, such as a cup at the end of the particular hole on the golf course or an intermediate landing point for a golf ball in play on the course. Other implementations are also possible, such as the launch area being one of multiple designated tee areas along a tee line where golfers can hit golf balls into an open field, or the launch area being one of multiple designated tee areas in the stands at a sports stadium where golfers can hit golf balls over and onto the playing field of the sports stadium

Two or more sensors 106, such as cameras (e.g., stereo camera pairs), radar devices (e.g., Doppler radar devices), or combinations thereof (e.g., a camera used to sense an angle to the ball in combination with a radar used to sense a distance and/or speed of the ball), are connected to the computer 102, either directly, or through one or more computing devices, which may perform various levels of processing on the data collected by the sensor(s) 106 prior to sending the processed data to the computer 102.

Generally, the sensor(s) 106 are located close to the launch area for the ball. However, in some implementations, one or more of the sensor(s) 106 can be located along one or both sides of the 3D space, and/or on the other side of the 3D space opposite the launch area. For example, at a golf tournament, the camera can be located behind the green, looking back at the golfer, assuming that shots will be hit towards the green. Thus, in various implementations, the sensors can observe and track objects that move away from a sensor, toward a sensor, and/or through the field of view of a sensor.

The sensor(s) 106 may have different sensitivity (e.g., different image sensor resolutions), and be of varying types (e.g., radars, cameras, or combinations thereof), which may affect the quality of the data that gets transmitted to the computer 102. However, the sensitivity of the sensor(s) 106 does not necessarily affect how the computer 102 operates, which will be described in further detail below with reference to FIG. 3. Thus, many variations of sensor setups and configurations exist.

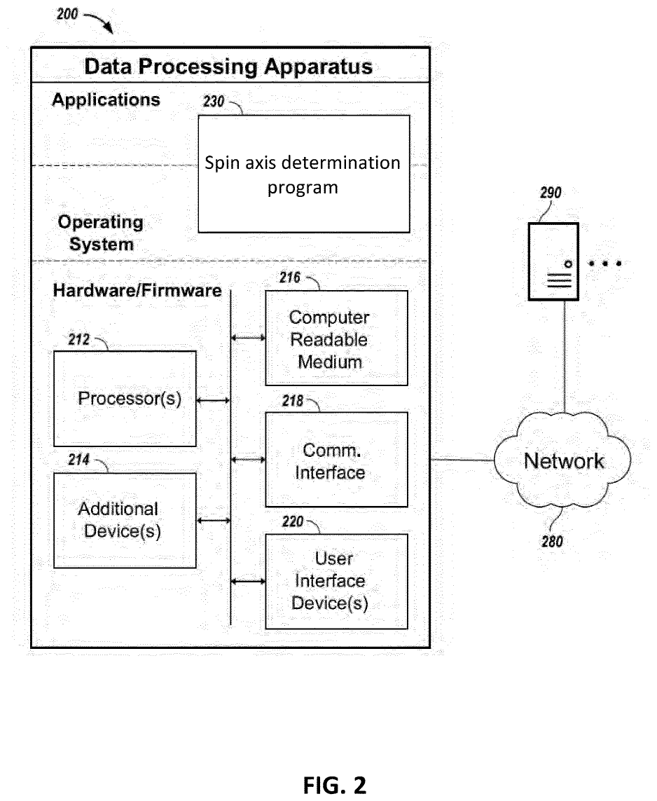

Distinct types of computers can be used in the system. The essential elements of a computer are a processor for performing instructions and one or more memory devices for storing instructions and data. As used herein, a “computer” can include a server computer, a client computer, a personal computer, embedded programmable circuitry, or a special purpose logic circuitry. FIG. 2 is a schematic diagram of a data processing system including a data processing apparatus 200, which represents an implementation of the computer 102. The data processing apparatus 200 can be connected with one or more computers 290 through a network 280.

The data processing apparatus 200 can include various software modules, which can be distributed between an applications layer and an operating system. These can include executable and/or interpretable software programs or libraries, including a program 230 which operates as a spin axis determination program for a trajectory, for example. The number of software modules used can vary from one implementation to another. Also, in some cases, the program 230 can be implemented in embedded firmware, and in other cases, the program 230 can be implemented as software modules that are distributed on one or more data processing apparatus connected by one or more computer networks or other suitable communication networks.

The data processing apparatus 200 can include hardware or firmware devices including one or more hardware processors 212, one or more additional devices 214, a non-transitory computer readable medium 216, a communication interface 218, and one or more user interface devices 220. The processor 212 is capable of processing instructions for execution within the data processing apparatus 200, such as instructions (e.g., of the program 230) stored on the non-transitory computer readable medium 216, which can include a storage device such as one of the additional devices 214.

In some implementations, the processor 212 is a single or multicore processor, or two or more central processing units (CPUs). The data processing apparatus 200 uses its communication interface 218 to communicate with one or more computers 290, for example, over the network 280. Thus, in various implementations, the processes described can be run in parallel, concurrently, or serially, on a single or multi-core computing machine, and/or on a computer cluster/cloud, etc.

Examples of user interface devices 220 include a display, a touchscreen display, a speaker, a microphone, a tactile feedback device, a keyboard, a mouse, and a headset or heads-up display of a virtual reality or augmented reality environment system. Moreover, the user interface device(s) need not be local device(s) 220 but can be remote from the data processing apparatus 200, e.g., user interface device(s) 290 accessible via one or more communication network(s) 280. For example, the user interface device(s) 220/290 can be a smartphone or a tablet computer of the user, e.g., for an augmented reality implementation. The data processing apparatus 200 can store instructions that implement operations as described in this document, for example, on the non-transitory computer readable medium 216, which can include one or more additional devices 214, for example, one or more of a floppy disk device, a hard disk device, an optical disk device, a tape device, and a solid-state memory device (e.g., a RAM drive).

Moreover, the instructions that implement the operations described in this document can be downloaded to the non-transitory computer-readable medium 216 over the network 280 from one or more computers 290 (e.g., from the cloud). In some implementations, the data processing apparatus 200 is a smartphone or a tablet computer. In some implementations, the RAM drive is a volatile memory device to which the instructions are downloaded each time the computer is turned on.

FIG. 3 is a flowchart illustrating a method 300 performed by the computer 102 when determining a spin axis, in accordance with some embodiments. As can be seen in FIG. 3, the method 300 starts by obtaining 302 sensor data for a ball trajectory, collected by the sensor(s) 106 as described above, and determining accelerations for multiple points along the trajectory. The obtaining 302 can involve retrieving the data from another computer/system or from local memory where that data has been actively pushed, or the obtaining 302 can involve passively receiving the data on an ongoing basis. It should be noted that in some embodiments, the sensor(s) 106 may not capture positional data, but instead velocity data for the ball. Irrespective of the type of data that is captured by the sensor(s) 106, the data can be converted into acceleration data, since the acceleration of the ball at any given point along its trajectory can be determined either as the first derivative of the velocity of the ball, or the second derivative of the position of the ball.

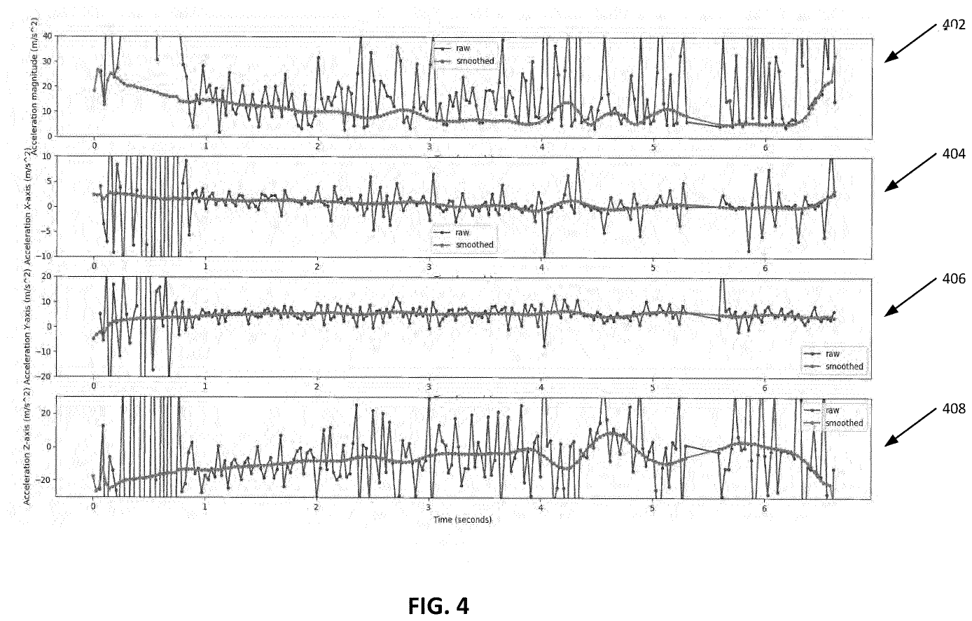

The jagged curves in FIG. 4 show an example of acceleration data that has been calculated for a ball in multiple positions along a trajectory based on positional observations by the sensor(s) 106. As can be seen in FIG. 4, in the illustrated embodiment, there are 30 recorded observation points for each second, i.e., the position of the ball is captured 30 times per second, or expressed differently, with a sampling frequency of 30 Hz. Again, it should be noted that this is merely one example, and that other sensor(s) 106 may have other sampling frequencies. For the sake of clarity, it should also be noted again that the concept of acceleration as used in this description refers to a 3D vector quantity, i.e., a direction and a magnitude, and not just a quantity, as may often be done in colloquial language use. Thus, the graph 402 illustrated in FIG. 4 shows the measured magnitude of the acceleration (vertical axis) of the ball over time (horizontal axis). The next graph 404 shows the measured acceleration in a horizontal direction (i.e., along an x-axis) over time. The next graph 406 shows the measured acceleration in a vertical direction (i.e., along a y-axis) over time. Finally, the bottom graph 408 of FIG. 4 shows the measured acceleration along the depth direction (i.e., along a z-axis) over time. That is, together the graphs 404-408 illustrate the ball's acceleration components along three perpendicular axes. These three components, along with the measured magnitude 402, form the total acceleration of the ball.

As can be seen by the jagged lines in FIG. 4, this data may be very noisy, in particular in the z-direction (i.e., graph 408), and would not be of much use in itself for purposes of calculating a spin axis. Therefore, the sensor data is smoothed, for example, by applying 304 a filter to the sensor data, which results in the smoother curves shown in FIG. 4. In one embodiment, an SG filter is applied. For the SG filter, the base polynomial can be of a low degree, such as a second- or third-degree polynomial, and the size of the window can be dependent on the sampling frequency and the amount of noise (i.e., a higher sampling frequency and/or a higher amount of noise requires a larger window).

However, there are many other alternatives to the SG filter, which are also available, such as smoothing splines, least square fits of polynomials. The fundamental criterion for selecting an appropriate filter is that a good compromise is reached between reducing the noise in the signal while also ensuring that the signal itself does not get lost, as may be the case, for example, if polynomial fits of a high degree are used. Furthermore, it is desirable to use a method that is not too complex, as there is typically a need to display the spin axis calculation results to a user with a “low delay” on the client computer 110. In practice “low delay” in this context means that all the spin axis calculations should preferably be finished within about half a second, which may influence the choice of a what model to use. Irrespective of which model is used, the end goal is the same, that is, to reduce the noise in the observations such that an optimization model can be applied to the received data, which allows a spin axis to be determined.

Even after smoothing, the outliers may still affect the data. As simplified illustration of this phenomenon, consider a time window during which the observation values [1, 10, 1, 1] occur. It is clear that the value 10 is an outlier in this situation, and that a more accurate representation of the observation values during the time window is the value 1. If an average were calculated for the time window, it would be 3.25, which does not reflect the observed value 1 very well. That is, the outlier still has an undesirable impact on the smoothed data. Therefore, prior to proceeding, such outliers are removed 306. Various criteria can be used to decide what outliers to remove. For example, in some implementations, outliers having a magnitude of acceleration that is excessively high (e.g., several g's) are removed. In some implementations, the outlier removal may be based on a standard deviation from the average measurements (so-called Z-scores), just to mention a couple of possible criteria by way of example.

Next, a wind velocity is obtained, 308. As will be explained in further detail below, knowing the wind velocity is important, in order to be able to subtract the wind velocity from the velocity of the ball when determining the ball's relative velocity to the air. Being able to do so avoids systematic errors due to wind, which may lead to over- or underestimation of the length and curve of the trajectory. It should be noted that a zero systematic error is not the same as a zero error, but rather means that the estimates lack bias to any specific direction.

In some embodiments, the wind velocity is obtained from external dedicated wind measuring equipment. In some embodiments a wind vector can be estimated by calculating a wind speed for each of several individual shots during a predefined time window, and determining a weighted average for the overall wind speed. Using several shots eliminates the uncertainty associated with calculating a wind speed based on an individual shot, and thus provides a more robust value of the wind vector.

In the event that a wind velocity cannot be obtained using any of the above methods, a wind velocity can instead be estimated using other techniques. One such technique involves a two-stage wind estimation technique, in which a first stage is used to determine whether there is “high” or “low” wind, followed by a second stage during the optimization process in which the actual wind is estimated and where the “high” or “low” value from the first stage is used as a parameter. The method 500 shown in FIG. 5 shows an example of an implementation of the first stage.

First, an optimization problem for the spin is solved 502, using only a subset of the data for the ball trajectory recorded by the sensor(s) 106, and without any wind estimate. The optimization equations are described below with respect to items 310-320 of FIG. 3, and the reader is kindly asked to refer to that section of the specification for the details on spin determination. The reason for using only a subset of the sensor data is to minimize the influence that other errors may have on the wind velocity estimate. Expressed differently, a much simpler optimization problem is solved. Through experimentation, the inventors have discovered, for a golf shot in particular, observed data from approximately the first 1.5 seconds of the trajectory to be a suitable criterion for selecting the subset. For other sports objects, the time period for selecting the subset may vary. If the subset is too large, there will be no systematic error due to wind, but on the other hand, there also needs to be a sufficient body of captured data. However, again it should be noted that this is merely one example value and that there may be many factors that impact how the subset of measurement data is selected. The solution to this optimization problem includes an initial state for a spin axis and a spin magnitude, representing the conditions when there is no wind.

Next, the estimated spin magnitude is integrated 504 from this initial state, i.e., initial location and initial spin parameters, to a reference state (the spin axis value remains at its initial state). In general, it is preferable for the reference state to be in the latter part of the trajectory, and preferably as late as possible, as this provides a larger body of data for which the systematic error can be determined.

A difference in velocity is then determined 506 between the integrated position/speed for the ball and the observed position/speed of the ball at the reference state. This velocity difference is considered to be an estimate of the systematic error in velocity due to the wind, i.e., a rough wind speed estimate. The difference can be determined either in terms of the position or velocity of the ball. When determined in terms of position, the distance is divided by the time over which the integration has occurred, so as to express the difference in terms of velocity.

Finally, the estimated wind velocity is converted 508 to a scalar in the range [0, 1], where zero represents “no wind” and one represents “high wind.” This scalar is subsequently used in the second stage of the wind estimation process, which occurs as part of the optimization process. In some embodiments, a minimum scalar value is set, e.g., “this value can never be less than x.” This minimum value serves as a safeguard for situations when the shot is so short that a systematic error due to wind cannot be determined, even when there is significant wind present. Through experimentation, the inventors have discovered that a suitable number for x in the case of a golf shot is 0.3, and again, for other sports object, a different value of x may be more suitable.

Returning now to FIG. 3, after the wind velocity is received 308 through one of the methods described, an optimization target and a set of optimization parameters are defined, 310, such that an optimization problem can be solved. In the embodiment described with respect to FIG. 3, the optimization problem is defined to use the 3D acceleration as calculated by the low pass filtering described in operation 304 as the optimization target, with the physics model of the golf ball being used to estimate the 3D acceleration of the ball, and given the unknown optimization parameters of spin magnitude, spin axis, and wind vector.

The noise in the measurements and the accuracy of the underlying physics model (in which certain simplifying assumptions have been made) for the ball's behavior poses many challenges on real world data. Some of them are managed as described above with respect to the operations in 304 and 306, but not all. In particular, the shape and structure of the loss function is important, and the inventors have determined through experimentation that the L2 squared loss function, which is commonly used in many optimization problems, typically does not work well on the real-world data collected by the sensor(s) 106.

Instead, the loss function used in with the embodiment of FIG. 3 is a Huber loss function, which is commonly used in the field of regression analysis, and which is less sensitive to outliers as compared to the L2 squared loss function. In addition, for each datapoint (i.e., point in time when trajectory data was captured about the ball), a weight is assigned. Outliers are assigned a low weight and hence have less influence on the estimated parameters. This is similar to iteratively reweighted least squares, which is also used in the art of regression analysis. The specific details of how these weights are updated will be described below, in particular with respect to operation 318. The optimization model can also use Regularization terms, which penalize the spin decay and wind magnitude. Regularization can be understood as a process that changes the result answer to be “simpler” in some sense. For example, the regularization terms can use the wind estimate calculated as described above with respect to FIG. 5.

Further, in the example embodiments described herein, the optimization methods are descent based, i.e., they use the derivative of the loss function in order to determine in what direction the optimization parameters should be changed to minimize the loss function. Given the external, player-driven need of the spin axis determination needing to be perceived as essentially instantaneous, the calculation of derivatives needs to be both fast and accurate. For that reason, the derivatives can be calculated using automatic differentiation (also known as algorithmic differentiation, computational differentiation, or auto-differentiation). In essence, automatic differentiation can be understood as a set of techniques to evaluate the derivative of a function specified by a computer program, by exploiting the fact that every computer program, no matter how complicated, executes a sequence of elementary arithmetic operations (addition, subtraction, multiplication, division, etc.) and elementary functions (exp, log, sin, cos, etc.). Thus, by repeatedly applying the chain rule to these operations, it is possible to compute derivatives of arbitrary order automatically and accurately to working precision. This computation involves, at most, a constant factor of arithmetic operations, compared to what is used in the original program. This is convenient, given the external constraints for the optimization method to be perceived as performing in real time. The use of derivatives in the loss function also means that the physics model used in the calculations needs to be differentiable. The part of the physics model that are not “naturally” differentiable are the measurements of the drag and lift coefficients. Thus, to make these functions differentiable, surface fitting and function approximation can be applied.

There are many possible options for choosing what optimization method to use. A common method for solving unconstrained nonlinear optimization problems, such as the ones described herein, is the Broyden-Fletcher-Goldfarb-Shanno (BFGS) algorithm, which is an iterative method. The BFGS algorithm determines the descent direction by preconditioning the gradient with curvature information. In the embodiments described herein, a particular variant of the BFGS algorithm is used, which is known as the L-BFGS algorithm with strong Wolfe line search as optimizer. The L-BFGS algorithm approximates the BFGS algorithm, using a limited amount of computer memory, and is therefore a popular algorithm for parameter estimation in machine learning.

Mathematically, in some embodiments the optimization problem may be defined as:

$${υ}_{rel} ( t ) = υ ( t ) - {υ}_{w} ( t , h )$$

$${u}_{D} - \frac{- {υ}_{rel} ( t )}{‖ {υ}_{rel} ( t ) ‖} , {u}_{L} = \frac{{α}_{d} \times {\hat{υ}}_{rel} ( t )}{‖ {α}_{d} \times {\hat{υ}}_{rel} ( t ) ‖}$$

$${\hat{a}}_{D} ( t ) = {u}_{D} \cdot {C}_{D} ( ‖ {υ}_{rel} ( t ) ‖ , {α}_{m} ( t ) ) \cdot K \cdot {‖ {υ}_{rel} ( t ) ‖}^{2}$$

$${\hat{a}}_{L} ( t ) = {u}_{L} \cdot {C}_{L} ( ‖ {υ}_{rel} ( t ) ‖ , {α}_{m} ( t ) ) \cdot K \cdot {‖ {υ}_{rel} ( t ) ‖}^{2}$$

$$\hat{a} ( t ) = g + {\hat{a}}_{D} ( t ) + {\hat{a}}_{L} ( t )$$

$$L = \frac{1}{\vert t ∈ T \vert} {\sum }_{t ∈ T} ( {w}_{t} \cdot d ( \hat{a} ( t ) - a ( t ) ) ) + {L}_{reg}$$

$${w}_{t} = \frac{1}{\vert \hat{a} ( t ) - a ( t ) \vert}$$

$${L}_{reg} = {p}_{w} \cdot {‖ {υ}_{w} ( {t}_{ref} , {h}_{ref} ) ‖}^{2} + {p}_{α} \cdot \frac{d {α}_{m} ( t )}{dt} {( {t}_{ref} )}^{2}$$

$${p}_{w} = {w}_{rough} \cdot {e}^{- {obs}_{dist}^{\frac{1}{2.8}}}$$

$${p}_{α} = constant$$

where d is the Huber loss function.
Unknowns: αₘ(t), α_{d}, v_{w}(t, h)

### Definitions

αₘ(t): Spin magnitude, function of time. Any function is possible, the linear function is just an example.
α_{d}: Spin vector (unit vector), constant over trajectory.
v_{w}(t, h): Wind vector. This can be described by many different functions, but in general it is a function of time and altitude. The most basic form is that it is constant over time and altitude. A more advanced form is that the magnitude increases with altitude (but the magnitude is constant at same altitude throughout the shot) but with constant direction.
v(t): Velocity of the ball.
vᵣₑₗ(t): Velocity of the ball relative to the air.
K: Constant involving ball mass, area, density of air, etc.
C_{D}(v,α), C_{L}(v,α): Drag and lift coefficients of the ball as a function of speed and spin.
â_{D}(t): Modelled drag acceleration.
â_{L}(t): Modelled lift acceleration.
â(t): Modelled total acceleration.
a(t): Observed total acceleration.
L: Loss function.
wₜ: Weight of loss function at this point.
Lᵣ: Regularization term of the loss function. This help guides the optimizer to desired solutions.
p_{w}: Penalization term for wind.
w_{rough}: The rough wind estimate.
obs_{dist}: The length of the observed part of the trajectory. The more measurements we get, the more wind we want to allow.
tᵣef,hᵣef: Where to regularize the parameters at. Typically, tᵣef=0 and hᵣef=10

After the optimization target and optimization parameters have been determined, the parameters are initialized, 312. The inventors have found through experimentation and for the particular example of a golf ball, that suitable initial parameter values are a zero value for the spin axis (i.e., pure back spin), zero value for wind (i.e., no wind), and that the spin magnitude has less influence than the other parameters and can be chosen arbitrarily.

Next, a regularized weighted loss function is calculated, 314, such as described above. The optimizer is then invoked, 316, m times using the L-BFGS optimization model described above. The weights assigned to the datapoints are then updated, 318. In some embodiments, the weights are updated using the L1 norm of the optimization target. The weight for a datapoint is defined as the inverse of the L1 norm between the goal and the estimated value of the datapoint. Operations 314-318 are then repeated a total of n times. It should be noted that if it is determined that the optimizer has converged, for example, when the norm of the gradient falls below a certain threshold or when the difference in target function between two iterations is below a certain value, then of course there is no need to continue the repetitions just simply for the purposes of reaching the number m or n, respectively, and instead the method can be terminated early. In the embodiments described herein, the values of m and n are determined experimentally, based on the quality of the data from the sensors and the available computing power.

After the completion of operations 314-318 n times, there are estimates of the unknown optimization parameters, that is, the spin axis, the spin magnitude, and the wind vector, which can be used for different purposes. For example, the spin axis can optionally be stored, used, or presented 320 in various types of applications, for example, allowing a user to benefit from the spin axis information to enhance his or her game, for example, by being provided with statistics and/or suggestions of different equipment to use, etc., which ends the method 300.

The spin axis determination using the systems and techniques described in this document make it possible to increase the robustness and accuracy of the spin axis determination compared to what is currently possible, or permit the use of different types of sensors that otherwise would have been too noisy to use in the context of spin axis calculations. Such sensors tend to be simpler and more affordable, as well as more robust, which allows for more widespread usage than what is currently possible. In addition, the spin axis can be determined quickly enough that a user perceives the determination to be instantaneous.

Since a difference as small as 1-2 degrees in the spin axis calculation can make a big difference when determining the trajectory of a ball, the optimization methods described herein can have a significant impact on the accuracy of the spin axis calculation and thus improve the accuracy of ball trajectory determination. The techniques described herein improve the functioning of a computer in terms of efficiently producing more accurate information to a player than what is currently possible as to the trajectory of the ball, both in an outdoor environment and in an indoor environment, such as a game facility, where the trajectory may need to be simulated in part due to space constraints. The spin axis information can be presented to the player in various formats. For example, some players may want to know numerical information, while others may be satisfied with knowing whether the shot is a slice, fade, draw, hook, etc. Yet other players may want to see graphical information outlining a shot on a display screen. Ultimately, the provided information can improve the skills of a player, which not only increases the enjoyment of the game, but also the safety of people sharing a common space with the player. The spin axis information can also be used to evaluate how well different types of equipment (e.g., balls, clubs, etc. made with different materials and designs) perform under different circumstances, thus ultimately contributing to developing better equipment.

The present invention also relates to a computer software function for determining a spin axis according to what has been described above. Such a computer software function is then arranged to, when executing, perform the above-described measuring, selecting, determining, using, computing, repeating, selecting, and using operations, which are also recited in the claims. The computer software function is arranged to execute on physical or virtual hardware of the computer 102 of the system and/or the data processing apparatus 200, as described above.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a non-transitory computer-readable medium for execution by, or to control the operation of, data processing apparatus. The computer-readable medium can be a manufactured product, such as a hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various computing model infrastructures, such as web services, distributed computing, and grid computing infrastructures.

A computer program (also known as a program, software, software application, script, or code) can be written in any suitable form of programming language, including compiled or interpreted languages, declarative or procedural languages, and it can be deployed in any suitable form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and one or more processors of any suitable digital computer. Generally, a processor will receive instructions and data from a read-only memory (ROM) or a random-access memory (RAM) or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; CD-ROM and DVDROM disks; network attached storage; and various forms of cloud storage. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display), OLED (organic light emitting diode) or other monitor, for displaying information to the user and a keyboard and a pointing device, e.g., a mouse or a trackball, by which the user can provide input to the computer. Other kinds of devices can be used to provide for interaction with a user as well; for example, feedback provided to the user can be sensory feedback, e.g., visual feedback, auditory feedback, or tactile feedback; and input from the user can be received in various forms, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any suitable combination of one or more such back-end, middleware, or front-end components. The components of the system can be interconnected by any suitable form or medium of digital data communication, e.g., a communication network. Examples of communication networks include a local area network (“LAN”) and a wide area network (“WAN”), an internetwork (e.g., the Internet), and peer-to-peer networks (e.g., ad hoc peer-to-peer networks).

While this specification contains many implementation details, these should not be construed as limitations on the scope of the invention or of what may be claimed, but as descriptions of features specific to implementations of the invention. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination. Thus, unless explicitly stated otherwise, or unless the knowledge of one of ordinary skill in the art clearly indicates otherwise, any of the features of the embodiment described above can be combined with any of the other features of the embodiment described above.

Similarly, while operations are depicted in the drawings in a particular order, this should not be understood as requiring that such operations be performed in the order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and the described program components and systems can be integrated together in a single software product or packaged into multiple software products.

Thus, embodiments of the invention have been described. Other embodiments are within the scope of the following claims. For example, the description above focuses on spin axis determination in the context of the motion of a golf ball, but the systems and techniques described are also applicable to other types of objects that move through the air and are affected by wind, such as for baseball or skeet shooting, as well as non-sports applications. The spin axis determination can be further refined by improving the wind velocity estimation, for example, by considering that the wind varies with the height above ground. Further, in the above examples, it has been assumed that acceleration of the ball is affected by gravity, lift, and drag only. However, there may be other forces at play too, for example, some kind of Coriolis effect, which can be used to further improve the physical model. The improvements that can be achieved through such changes to the physical model, though, need to be considered in view of the accuracy of the data registered by the sensors, wind measurements/estimations, etc., which may have a greater overall influence on the resulting spin axis determination.

Furthermore, it should be noted that the techniques described herein are applicable to setups using one or more sensors to observe the trajectory of the ball. For example, a single sensor (such as a Doppler radar, for example) can be used to observe both angle and distance, and thus no further sensors are needed. Other setups may use various combinations of cameras and radar sensors.

In addition, while the various embodiments described herein refer to the broad class of descent-based optimization methods, it should be noted that there may also be other optimization methods that could be used, which does not fall into this family of optimization methods. The various embodiments described above refer to “automatic differentiation.” However, it should be realized that there could also be embodiments that use numerical. Thus, many variations to the above examples lie well within the scope of the attached claims and within the capabilities of a person having ordinary skill in the art.

1. A method for determining a spin axis of a ball in flight, comprising:
obtaining at least a portion of an observed trajectory of the ball, the observed trajectory comprising three-dimensional locations of the ball over time, as determined from individual observations of the ball by one or more sensors;
selecting a point in three-dimensional space;
solving an optimization problem, wherein a three-dimensional acceleration at the selected point in three-dimensional space is used as an optimization target, and a spin axis, a spin magnitude and a wind vector are used as optimization parameters, wherein a solution to the optimization problem is a combination of optimization parameter values;
selecting, as a spin axis of the ball, the spin axis determined in the solution to the optimization problem; and
using the selected spin axis of the ball to generate ball trajectory information to be presented on an output device.

2. The method of claim 1, wherein solving an optimization problem comprises:
initializing values for the optimization parameters;
calculating a regularized weighted loss function;
optimizing m steps using a descent-based optimization;
updating point weights; and
repeating the calculating, optimizing, and weighting n times or until convergence.

3. The method of claim 2, wherein the one or more sensors include a radar, a camera, or both.

4. The method of claim 2, further comprising smoothing at least a portion of an observed trajectory of the ball, using a Savitzky-Golay filter.

5. The method of claim 2, further comprising removing acceleration outliers prior to solving the optimization problem.

6. The method of claim 2, further comprising:
obtaining a wind velocity representing prevailing wind conditions during the flight of the ball; and
using the obtained wind velocity when initializing the wind vector.

7. The method of claim 6, wherein the wind velocity is obtained by estimating a systematic error between corresponding sections of an estimated trajectory of the ball and the observed trajectory of the ball.

8. The method of claim 2, wherein the three-dimensional acceleration of the ball at the selected point in three-dimensional space comprises an acceleration component due to gravity, an acceleration component due to drag, and an acceleration component due to lift, and wherein the acceleration component due to lift is used as an initialization value for the spin axis.

9. The method of claim 8, wherein the ball is a golf ball, and the method is performed at a golf practice range or golf course.

10. The method of claim 9, wherein the regularized weighted loss function is a Huber loss function.

11. The method of claim 10, further comprising:
determining whether the optimizing is converging; and
in response to determining that the optimizing is converging, repeating the calculating, optimizing, and weighting fewer than n times.

12. The method of claim 11, wherein calculating a regularized weighted loss function is done by automatic differentiation.

13. The method of claim 12, wherein the descent-based optimization is a Broyden-Fletcher-Goldfarb-Shanno algorithm.

14. A non-transitory computer readable medium encoding a computer software product arranged to, when executed, perform operations comprising:
obtaining at least a portion of an observed trajectory of a ball in flight, the observed trajectory comprising three-dimensional locations of the ball over time, as determined from individual observations of the ball by one or more sensors;
selecting a point in three-dimensional space;
solving an optimization problem, wherein a three-dimensional acceleration at the selected point in three-dimensional space is used as an optimization target, and a spin axis, a spin magnitude and a wind vector are used as optimization parameters, wherein a solution to the optimization problem is a combination of optimization parameter values;
selecting, as a spin axis of the ball, the spin axis determined in the solution to the optimization problem; and
using the selected spin axis of the ball to generate ball trajectory information to be presented on an output device.

15. A system for determining a spin axis of a ball in flight, the system comprising:
a processor; and
one or more memory devices for storing instructions, which when executed by the processor cause the processor to perform operations comprising:
obtaining at least a portion of an observed trajectory of the ball, the observed trajectory comprising three-dimensional locations of the ball over time, as determined from individual observations of the ball by one or more sensors;
selecting a point in three-dimensional space;
solving an optimization problem, wherein a three-dimensional acceleration at the selected point in three-dimensional space is used as an optimization target, and a spin axis, a spin magnitude and a wind vector are used as optimization parameters, wherein a solution to the optimization problem is a combination of optimization parameter values;
selecting, as a spin axis of the ball, the spin axis determined in the solution to the optimization problem; and
using the selected spin axis of the ball to generate ball trajectory information to be presented on an output device.

16. The non-transitory computer readable medium of claim 14, wherein solving an optimization problem comprises:
initializing values for the optimization parameters;
calculating a regularized weighted loss function;
optimizing m steps using a descent-based optimization;
updating point weights; and
repeating the calculating, optimizing, and weighting n times or until convergence.

17. The non-transitory computer readable medium of claim 16, wherein the one or more sensors include a radar, a camera, or both.

18. The non-transitory computer readable medium of claim 16, the operations further comprising removing acceleration outliers prior to solving the optimization problem.

19. The non-transitory computer readable medium of claim 16, the operations further comprising:
obtaining a wind velocity representing prevailing wind conditions during the flight of the ball; and
using the obtained wind velocity when initializing the wind vector.

20. The non-transitory computer readable medium of claim 19, wherein the wind velocity is obtained by estimating a systematic error between corresponding sections of an estimated trajectory of the ball and the observed trajectory of the ball.
